(19) United States
(12) Patent Application Publication
(10) Pub. No.: US 2015/0039436 A1
(43) Pub. Date: Feb. 5, 2015

(54) Method and system for targeted information dissemination

(71) Applicant: IADEA CORPORATION, Taipei (TW)

(72) Inventors: Chia-Chin Wang, Taipei City (TW); Yung-Chieh Lin, Taipei City (TW)

(73) Assignee: IADEA CORPORATION, Taipei (TW)

(21) Appl. No.: 14/205,290

(22) Filed: Mar. 11, 2014

Related U.S. Application Data
(63) Continuation-in-part of application No. 13/957,412, filed on Aug. 1, 2013.

(51) Int. Cl. G06Q 30/02

(52) U.S. Cl. CPC G06Q 30/0261
USPC 705/14.58

(57) ABSTRACT

A targeted information dissemination system includes a database, a player, a control device and a plurality of detecting devices. The player, control device and at least one detecting device may be disposed on a public area. If a portable device of a consumer has been detected by the at least one detecting device in the public area, media contents according to preference of the consumer may be played on the player.

### CROSS REFERENCE TO RELATED APPLICATIONS

This is a continuation-in-part of application Ser. No. 13/957,412, filed Aug. 1, 2013.

### BACKGROUND OF THE INVENTION

1. Field of the Invention

The present invention relates to a method and system for targeted information dissemination, and more particularly, a method and system for targeted information dissemination to play media contents of a store and charge a fee to the store according to data from a database.

2. Description of the Prior Art

Public displays are installed at many retail locations and event venues to display information. However they are often ignored by viewers largely because the information presented on the public displays does not relate to interests of consumers. Though sensors may be able to sense the presence of consumers, it fails to identify characters of the consumers such as gender, age, and interest. Therefore the display of information may only be initiated by the sensors to start viewing of the information but fails to identify suitable information for the consumer viewing the information. Thus, rendering the information displayed to be unappealing. This would also mean that stores paying for advertising would not get effective advertisements since the targeted consumers of the store might not even be the ones seeing the information of the store.

### SUMMARY OF THE INVENTION

An embodiment of a targeted information dissemination system is disclosed. The targeted information dissemination system comprises at least one detecting device configured to detect wireless signals transmitted by a portable device and transmit an identification of the portable device, a database configured to record the identification and determines a location of the portable device after receiving the identification of the portable device, a control device configured to generate at least one media content according to preference inferred from data corresponding to the identification of the portable device, and a player configured to play the at least one media content at a proximity of the portable device.

An embodiment of a targeted information dissemination method is disclosed. The targeted information dissemination method comprises at least one detecting device detecting wireless signals transmitted from a portable device, the detecting device transmitting an identification of the portable device to a database after detecting the wireless signals transmitted from the portable device, generating at least one media content according to preference inferred from data corresponding to the identification of the portable device, and playing the at least one media content at a proximity of the portable device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a first embodiment of a targeted information dissemination system according to the present invention.

FIG. 2 illustrates a second embodiment of the targeted information dissemination system in FIG. 1.

FIG. 3 illustrates a third embodiment of the targeted information dissemination system in FIG. 1.

FIG. 4 illustrates a flowchart of a targeted information dissemination method according to the present invention.

### DETAILED DESCRIPTION

A targeted information dissemination system can be facilitated in an organization such as a shopping center, a school or any other organization. As an example to illustrate the aspects of the present invention for clarity, following paragraphs will describe the targeted information dissemination system being implemented in a shopping center. The targeted information dissemination system will have some detection device placed in public areas such as food courts, elevator areas and rest areas of the shopping center. And some other detection device shall be placed in stores of the shopping center. A target location of the targeted information dissemination system may be a store. The example is not intended to limit the scope of the invention.

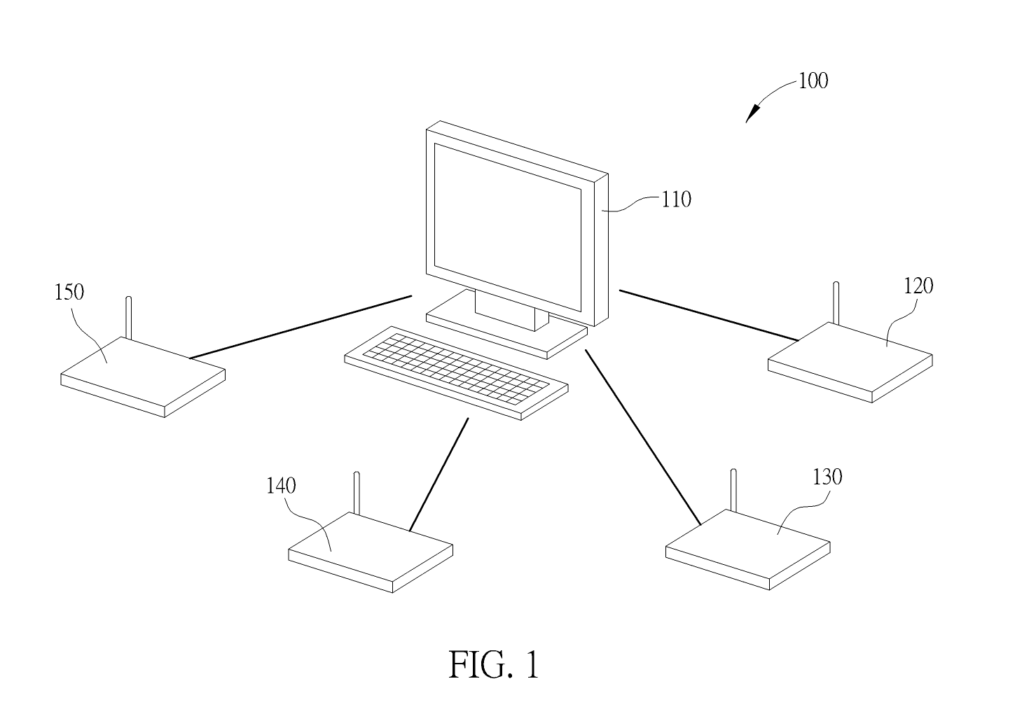

Please refer to FIG. 1. FIG. 1 illustrates a first embodiment of a targeted information dissemination system 100 according to the present invention. The targeted information dissemination system 100 comprises a database 110 and a plurality of detecting devices 120, 130, 140, and 150. Each of the plurality of detecting devices 120, 130, 140, and 150 may be a WiFi (wireless fidelity) access point or a Bluetooth transceiver and is assigned at least one attribute value and an identification. The plurality of detecting devices 120, 130, 140, and 150 are able to detect portable devices. The database 110 is used to receive and record all transmissions from the plurality of detecting devices 120, 130, 140, and 150. The data transmitted by the plurality of detecting devices 120, 130, 140, and 150 may include identifications of detecting devices and identifications of portable devices. Each of the plurality of detecting devices 120, 130, 140, and 150 may be placed in a location such as a public space or a private space. Thus the identifications of detecting devices may be used to indicate locations of the detecting devices 120, 130, 140, and 150. The identification may be a numeric, an alphabet or an alphanumeric combination with a predetermined number of characters.

The number of detecting devices is not limited to the plurality of detecting devices 120, 130, 140, and 150 shown in FIG. 1. FIG. 1 is only an example to illustrate the aspect of the present invention for clarity and not intended to limit the scope of the invention.

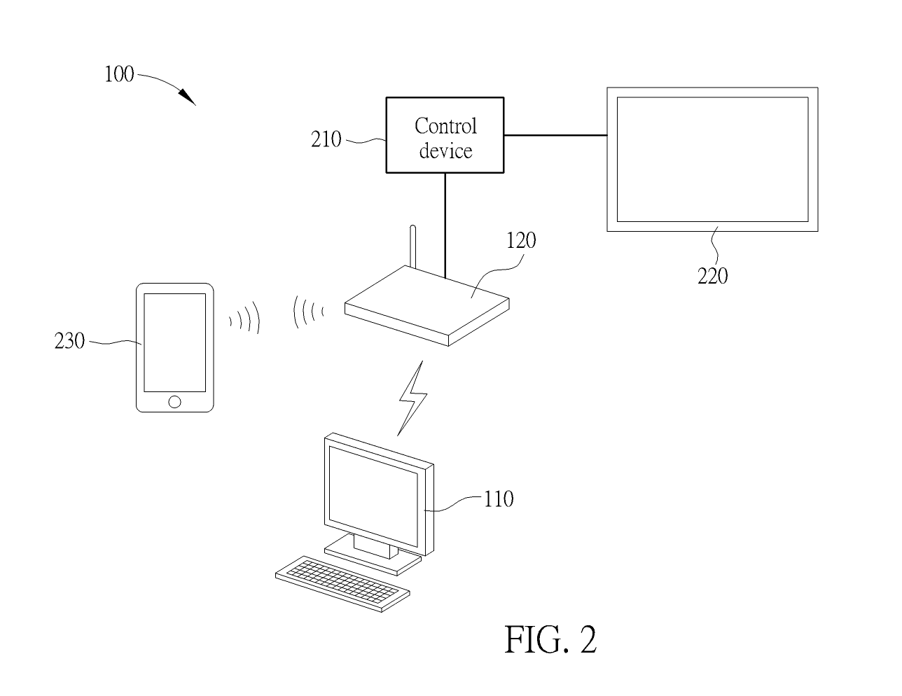

Please refer to FIG. 2. FIG. 2 illustrates a second embodiment of the targeted information dissemination system 100 in FIG. 1. In FIG. 2, the targeted information dissemination system 100 comprises a control device 210, a player 220, the database 110 and a detecting device 120 disposed at a public area such as a food court of the shopping center. When a portable device 230 of a consumer emits a wireless signal and the wireless signal is received by the detecting device 120, the detecting device 120 will transmit the identifications of the detecting device 120 and the identification of the portable device 230 to the database 110. The detecting device 120 is used to determine the location of the portable device 230. Alternatively, the location of the portable device 230 may be inferred using records of identifications of a plurality of detecting devices that has detected portable device 230 within a predetermined time interval using an algorithm such as triangulation. The identification of the portable device 230 maybe a MAC (media access control) address of the portable device 230.

When the detecting device 120 detects the wireless signal of the portable device 230, the identification of the portable device 230 is transmitted to the database 110. The identification of the detecting device 120 is transmitted to the database 110 as well. The identification of the detecting device 120 may be used to determine the location of the portable device 230. Alternatively, the location of the portable device 230 may be inferred by combing through detection records in the database 110 of a plurality of detecting devices corresponding to the portable device 230 within the predetermined time interval using an algorithm such as triangulation. The database 110 may generate a timestamp when a transmission from the detecting device 120 is received. The control device 210 may also receive the identification of the portable device 230. The control device 210 may use the identification of the portable device 230 to access data specific to the portable device 230 in the database 110. The data from the database 110 may be used to infer preference of a consumer. Inferred preference of the consumer may be classified under category of age, gender, and/or income of the consumer. Based on the inferred preference, the control device 210 decides on which contents are to be played on the player 220. The number of media contents that may be played is not limited to one, and the media contents may be advertisements of stores. The media contents may be multimedia files containing video contents, audio contents and/or images. The media contents may be stored in any memory accessible to the targeted information dissemination system 100.

The detecting device 120 is not limited to detecting a single portable device at one time. The detecting device 120 may be able to detect a plurality of portable devices as long as the plurality of portable devices is within the detecting proximity of the detecting device 120. Each of the plurality of portable devices corresponds to a consumer. The control device 210 is able to infer preference from data of the database 110 and play media contents that are suitable for the majority of consumers corresponding to the plurality of portable devices detected.

The order and time slots allocated to play the media contents may correspond to inferred preference from data of a consumer or consumers recorded within a predetermined period of time, time of detection, and/or willingness of a store to pay for advertising. The time of detection may refer to detection being made during breakfast time, lunch time or dinner time where restaurant ads maybe preferably played by the targeted information dissemination system 100.

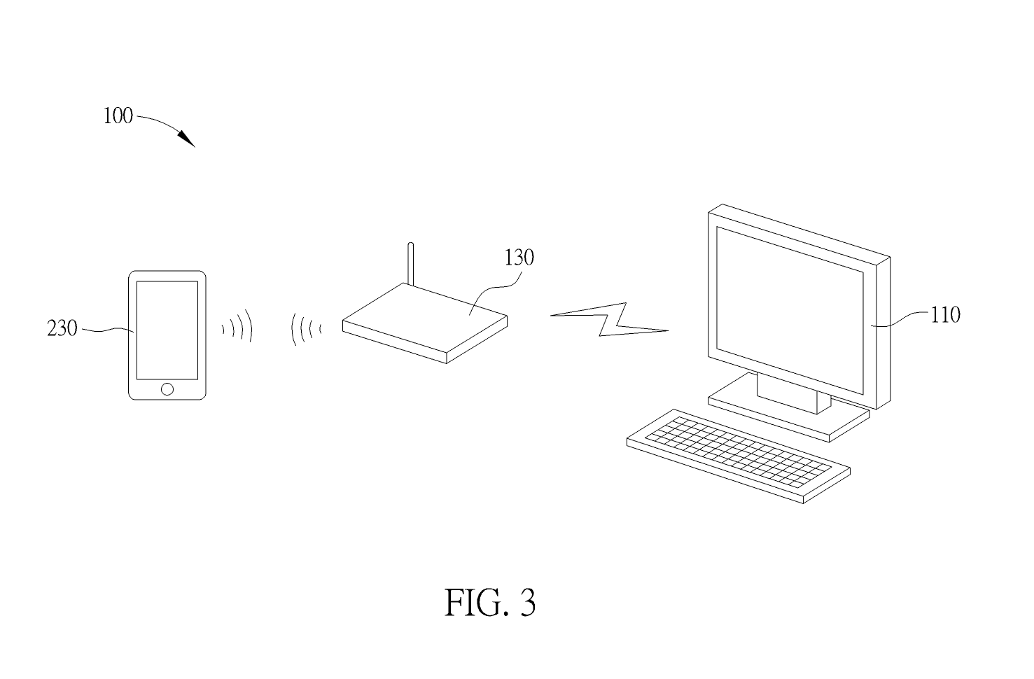

Please refer to FIG. 3. FIG. 3 illustrates a third embodiment of the targeted information dissemination system 100 in FIG. 1. In FIG. 3, the targeted information dissemination system 100 comprises a detecting device 130 disposed in a store of the shopping center, and the database 110. When the detecting device 130 detects the portable device 230 of the consumer, the detecting device 130 transmits the identification of the portable device 230 and the identification of the detecting device 130 to the database 110, and the database 110 may generate a timestamp to record the time. If the identification of the portable device 230 and the identification of the detecting device 130 are received by the database 110 within a predetermined time after the advertisement (media content) of the store is played to the consumer corresponding to the portable device 230, the store is to be charged a fee.

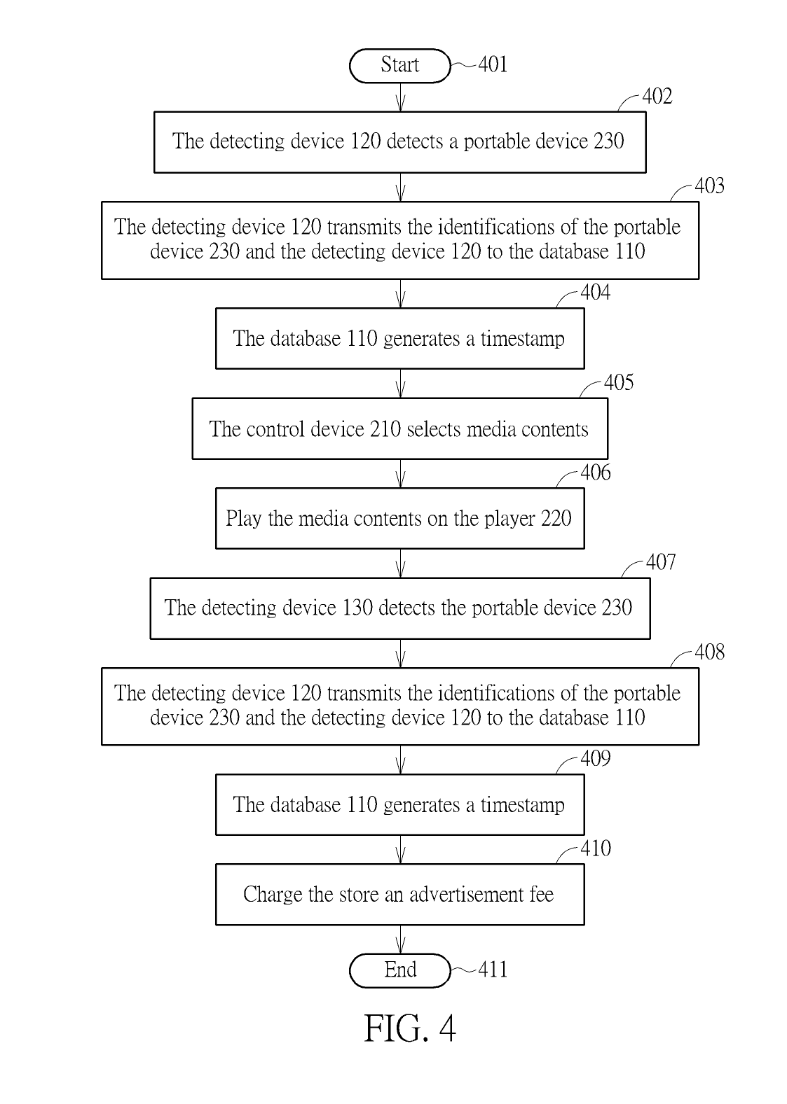

Please refer to FIG. 4. FIG. 4 illustrates a flowchart of a targeted information dissemination method according to the present invention. The targeted information dissemination method may include but is not limited to the following steps:

Step 401: Start;

Step 402: The detecting device 120 detects wireless signals emitted by a portable device 230;

Step 403: The detecting device 120 transmits the identification of the portable device 230 and the identification of the detecting device 120 to the database 110 after detecting the wireless signals emitted by the portable device 230;

Step 404: The database 110 generates a timestamp when the identification of the portable device 230 is received from the detecting device 120;

Step 405: The control device 210 selects media contents according to preference inferred from data corresponding to the identification of the portable device 230;

Step 406: Play media contents on the player 220 at proximity of the portable device 230;

Step 407: The detecting device 130 monitoring a store associated with one of the media contents detects wireless signals emitted by the portable device 230 after the media content is played;

Step 408: The detecting device 130 transmits the identification of the portable device 230 and the identification of the detecting device 130 to the database 110 after detecting the wireless signals emitted by the portable device 230;

Step 409: The database 110 generates a timestamp when the identification of the portable device 230 is received from the detecting device 130;

Step 410: Charge the store an advertisement fee if the identification of the portable device 230 and the identification of the detecting device 130 are received by the database 110 within a predetermined time after the advertisement of the store is played to the consumer corresponding to the portable device 230;

Step 411: End.

The database 110 may comprise of plurality of datasets corresponding to transmission of detecting devices. A dataset in the database 110 may include an identification of a detecting device, an identification of a portable device and timestamp of a time a detection of the portable device by the detection device.

When the detection device 120 detects the portable device 230, the control device 210 uses data from the database 110 corresponding to the portable device 230 to determine which media contents are played. The data corresponding to the portable device are datasets that include identification of the portable device 230. The number of datasets used by the control device 210 maybe a predetermined number of datasets or datasets that have been recorded in the database within a predetermined period of time. From identifications of detecting devices from the datasets corresponding to the portable device 230, a list of attribute values corresponding to the detecting devices may be extracted from the database. The attribute values of the detecting devices are used to correlate the different stores corresponding to the detecting devices to each other. Stores having same product types may have a common attribute value. An attribute value with the highest count extracted from the datasets corresponding to the portable device 230 would be used by the control device 210 to select media contents of stores having the same attribute value to play on the player 220.

The identification of the detecting device 120 sent to the database 110 in Step 403 may indicate the location of the portable device at the time of detection. The portable device 230 may also be detected by a plurality of detecting devices as long as the portable device 230 is within the detecting proximity of the plurality of detecting devices. The database 110 may receive and record datasets corresponding to identification of each of the plurality of detecting devices that has detected the portable device 230 within a predetermined time interval. The datasets within the predetermined time interval may be used by an algorithm such as triangulation to determine the location of the portable device 230 at a certain time.

When the location of the portable device 230 is determined through the algorithm such as triangulation, a player nearest to the location of the portable device 230 shall play media contents corresponding to the preference inferred from data corresponding to the identification of the portable device 230.

The identification of the detecting device 130 sent to the database 110 in Step 407 may indicate the location of the portable device is at the store at the time of detection. The portable device 230 may also be detected by a plurality of detecting devices as long as the portable device 230 is within the detecting proximity of the plurality of detecting devices. The database 110 may receive and record datasets corresponding to identification of each of the plurality of detecting devices that has detected the portable device 230 within a predetermined time interval. The datasets within the predetermined time interval may be used by an algorithm such as triangulation to determine the location of the portable device 230 at a certain time is at the store.

When the location of the portable device 230 is determined to be at the store within a predetermined time after the advertisement of the store is played to the consumer corresponding to the portable device 230, the store shall be charged a fee.

If a plurality of portable devices is detected at the same time, datasets corresponding to the plurality of portable devices is extracted from the database. Identifications of detecting devices from the datasets may be extracted as well as the attribute values of the detecting devices. An attribute value with the highest count extracted from the datasets corresponding to the plurality of portable devices would be used by the control device 210 to select media contents of stores having the same attribute value to play on the player 220.

A combination of attribute values may be used to be more specific in the selection of media contents. The combination of attribute values is also used by the control device 210 to make decision for sequence of playing the media contents. A detecting device configured to monitor a store may be assigned a combination of attribute values. Attribute values may be categorized into groups, e.g. product, value, and age bracket, to avoid confusion in using combinations of attribute values. Attribute values having the highest count under different categories may be taken as a combination of attribute values and used to match to stores having the closest combination of attribute values.

The control device 210 may prevent the player 220 from playing repeated media contents, the repeated media contents referring to media contents that has already been shown to the owner of the portable device 230 within a predetermined period of time but would still allow playing of media contents that contain the same information but presented in a different version. The control device 210 may also transmit data to the database 110. The data transmitted by the control device 210 to the database 110 may include identifications of media contents played in the player 220. An identification of each of the media contents maybe correlated to an identification of a detecting device monitoring a store in the database 110 to be able to correlate media contents to their corresponding stores. The data from the database 110 maybe correlated to each other as required by the system.

The use of the targeted information dissemination system 100 would allow the stores to have an effective advertising system. Data from a database that has been gathered by receiving and recording transmissions from detecting devices is analyzed. Based on the analyzed data, a player would play media contents that are suitable to owners of portable devices detected by a detecting device within the proximity of the player. And repetition of media contents shown to owners of portable devices can also be avoided. The data from the database may also be analyzed to decide if stores are to be charge a fee for advertisement services.

The location of a portable device may be inferred by combining datasets corresponding to the portable device being detected by a plurality of detection devices within a predetermined time interval by using algorithms such as triangulation. The triangulation of the location of the portable device may be used to determine whether the advertisement is to be deemed effective. In such case, the proximity of the portable device to a store can be confirmed without a physical detection device physically present at the store, but decided by several detection devices in the nearby vicinity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A targeted information dissemination system, comprising:
at least one detecting device configured to detect wireless signals transmitted by a portable device and transmit an identification of the portable device;
a database configured to record the identification and determines a location of the portable device after receiving the identification of the portable device;
a control device configured to generate at least one media content according to preference inferred from data corresponding to the identification of the portable device; and
a player configured to play the at least one media content at a proximity of the portable device.

2. The system of claim 1, wherein the at least one detecting device is further configured to transmit at least one identification of the at least one detecting device to the database when transmitting the identification of the portable device.

3. The system of claim 2, wherein the database determines the location of the portable device by using an algorithm on the at least one identification of the at least one detecting device transmitted to the database when transmitting the identification of the portable device.

4. The system of claim 1, further comprising at least one detecting device configured to monitor a target location associated with one of the at least one media content.

5. The system of claim 4, wherein the target location is charged a fee if the at least one detecting device configured to monitor the target location determines that the portable device is at the target location.

6. The system of claim 4, wherein the at least one detecting device configured to monitor the target location transmits the identification of the portable device to the database if the at least one detecting device configured to monitor the target location detects wireless signals transmitted from the portable device.

7. The system of claim 6, wherein the at least one detecting device configured to monitor the target location transmits at least one identification of the at least one detecting device configured to monitor the target location to the database when transmitting the identification of the portable device.

8. The system of claim 1, wherein the at least one media content is at least one multimedia content.

9. The system of claim 1, wherein each of the at least one detecting device is a WiFi (wireless fidelity) access point, a WiFi transceiver or a Bluetooth transceiver.

10. The system of claim 1, wherein the database is further configured to generate a timestamp when receiving the identification of the portable device.

11. A targeted information dissemination method, comprising:
at least one detecting device detecting wireless signals transmitted from a portable device;
the at least one detecting device transmitting an identification of the portable device to a database after detecting the wireless signals transmitted from the portable device;
generating at least one media content according to preference inferred from data corresponding to the identification of the portable device; and
playing the at least one media content at a proximity of the portable device.

12. The method of claim 11, further comprising the at least one detecting device transmitting at least one identification of the at least one detecting device to the database when transmitting the identification of the portable device.

13. The method of claim 12, further comprising the database determining a location of the portable device by using an algorithm on the at least one identification of the at least one detecting device transmitted to the database when transmitting the identification of the portable device.

14. The method of claim 11, further comprising at least one detecting device monitoring a target location associated with one of the at least one media content detecting wireless signals transmitted from the portable device after the media content is played.

15. The method of claim 14, further comprising charging a fee after the at least one detecting device monitoring the target location determines that the portable device is at the target location.

16. The method of claim 14, further comprising the at least one detecting device monitoring the target location transmitting the identification of the portable device to the database after detecting the wireless signals transmitted from the portable device.

17. The method of claim 16, further comprising the at least one detecting device monitoring the target location transmitting at least one identification of the at least one detecting device monitoring the target location to the database when transmitting the identification of the portable device.

18. The method of claim 11, wherein the at least one media content is at least one multimedia content.

19. The method of claim 11, wherein each of the at least one detecting device is a WiFi (wireless fidelity) access point, a WiFi transceiver or a Bluetooth transceiver.

20. The method of claim 11, further comprising the database generating a timestamp when receiving the identification of the portable device.
